(19) United States
(12) Patent Application Publication
(10) Pub. No.: US 2020/0225439 A1
(43) Pub. Date: Jul. 16, 2020

(54) IMAGING DEVICE

(71) Applicant: Nidec Copal Corporation, Tokyo (JP)

(72) Inventor: Yuta NAKAMURA, Tokyo (JP)

(21) Appl. No.: 16/633,898

(22) PCT Filed: Jul. 25, 2018
(86) PCT No.: PCT/JP2018/027801

§ 371 Date: Jan. 24, 2020

(30) Foreign Application Priority Data
Jul. 27, 2017 (JP) 2017-145066
Aug. 30, 2017 (JP) 2017-165104
Sep. 7, 2017 (JP) 2017-172475

(51) Int. Cl. G02B 7/02; G03B 17/02; G02B 7/04; G02B 7/00; H04N 5/225

(52) U.S. Cl. CPC G02B 7/021; G03B 17/02; G02B 7/023; G02B 7/026; G02B 7/003; H04N 5/2253; H04N 5/2254; G02B 7/04

(57) ABSTRACT

An imaging device includes a substrate on which an image sensor is mounted, a lens barrel holding a lens, a holder holding the lens barrel and connected to the substrate, a first urging member located between the holder and the lens barrel to urge the lens barrel relative to the holder in a direction of an optical axis, at least one second urging member located between the holder and the substrate to urge the substrate relative to the holder in the optical axis direction, and at least one fastener connecting the holder and the substrate together to adjust a distance between the holder and the substrate in the optical axis direction. The lens barrel is movable relative to the holder in a direction perpendicular to the optical axis.

### RELATED APPLICATIONS

The present application is National Phase of International Application Number PCT/JP2018/027801, filed Jul. 25, 2018, and claims priority based on Japanese Patent Application Nos. 2017-145066, filed Jul. 27, 2017, 2017-165104, filed Aug. 30, 2017 and 2017-172475, filed Sep. 7, 2017.

### FIELD

An embodiment of the present invention relates to, for example, an imaging device.

### BACKGROUND

In an imaging device including a lens barrel and a substrate on which an image sensor is mounted, the lens barrel is positioned with respect to the image sensor to adjust the optical axis. Adjustment of the optical axis includes adjusting the distance between the image sensor and the lens in the optical axis direction (focus adjustment), adjusting the relative position between the image sensor and the lens in a direction perpendicular to the optical axis (shift adjustment), and adjusting the tilt between the image sensor and the lens (tilt adjustment). Patent Literatures 1 to 3 describe known structures for precisely adjusting the optical axis.

### CITATION LIST

### Patent Literature

Patent Literature 1: Japanese Unexamined Patent Application Publication No. 2005-94731

Patent Literature 2: Japanese Unexamined Patent Application Publication No. 2006-308987

Patent Literature 3: Japanese Unexamined Patent Application Publication No. 2012-49621

### BRIEF SUMMARY

### Technical Problem

As imaging devices such as cameras become compact and highly precise, the optical axis is to be adjusted with higher precision than before and to be retained in position after the imaging device is assembled. However, known structures may not adjust the optical axis sufficiently precisely, or may have the optical axis misaligned after assembly, thus possibly degrading reliability.

### Solution to Problem

In response to the above issue, one or more aspects of the present invention are directed to the structures described below. The reference numerals or other labels in parentheses herein denote the corresponding components in the figures to facilitate understanding of the aspects of the present invention. However, the components with such reference numerals do not limit the components according to the aspects of the present invention, which should be construed broadly within the scope technically understandable by those skilled in the art.

An imaging device according to a first aspect of the present invention includes a substrate (5) on which an image sensor is mounted, a lens barrel (3) holding a lens, a holder (1) holding the lens barrel and connected to the substrate, a first urging member (2) located between the holder and the lens barrel to urge the lens barrel relative to the holder in a direction of an optical axis, at least one second urging member (4a to 4d) located between the holder and the substrate to urge the substrate relative to the holder in the optical axis direction, and at least one fastener (6a to 6f) connecting the holder and the substrate together to adjust a distance between the holder and the substrate in the optical axis direction. The lens barrel (3) is movable relative to the holder (1) in a direction perpendicular to the optical axis.

The imaging device with the above structure allows relatively easy positioning with respect to the optical axis in any direction. Without using an adhesive, this structure reduces the possibility that the optical axis is misaligned under temperature changes after the device assembly. This increases precision in adjusting the optical axis, and improves reliability.

In the above imaging device, the at least one fastener may be at least one positioning member placed through the holder from front to rear in the optical axis direction. The at least one second urging member may urge the substrate relative to the holder frontward in the optical axis direction.

In the imaging device with the above structure, the positioning member (e.g., a screw) is placed through the holder from the front in the optical axis direction, allowing the distance between the holder and the substrate to be adjusted from the front in the optical axis direction. This also allows all the adjustment operations for the optical axis from the front in the optical axis direction, thus increasing the efficiency of adjusting the optical axis.

In the above imaging device, the at least one positioning member may include a plurality of positioning members (6a to 6c). The plurality of positioning members may each independently adjust the distance between the holder and the substrate in the optical axis direction.

In the imaging device with the above structure, the substrate can be retained more stably in position with respect to the holder. This allows easy adjustment of the tilt between the image sensor mounted on the substrate and the lens.

In the above imaging device, the at least one positioning member may include a screw. The distance between the holder and the substrate in the optical axis direction may vary in accordance with a length of thread engagement between the screw and the holder.

The imaging device with the above structure allows relatively easy adjustment of the distance and the tilt between the image sensor and the lens using the screw.

In the above imaging device, the at least one positioning member may include a head and a shank. The shank may include a first shank section (6f1) with a threaded outer peripheral surface, and a second shank section (6f2) with a smooth outer peripheral surface and in contact with the substrate.

In the imaging device with the above structure, the portion of the positioning member in contact with the substrate has no thread on its outer peripheral surface. This eliminates wear debris resulting from thread engagement, and can prevent such wear debris from accumulating on the image sensor mounted on the substrate.

In the above imaging device, the at least one second urging member (4c, 4d) may urge the substrate relative to the holder frontward in the optical axis direction and in a direction perpendicular to the optical axis.

In the imaging device with the above structure, the urging force acts in the rotation direction of the lens barrel. This reduces rattling of the lens barrel in the rotation direction, thus allowing the lens barrel to rotate in position.

In the above imaging device, the at least one second urging member may include at least one spring (4c, 4d). The holder may include a first spring connector (1j, 1k) connected to one end of the spring. The substrate may include a second spring connector (5c, 5d) connected to another end of the spring. The first spring connector and the second spring connector may be at different positions in a plan view perpendicular to the optical axis.

In the imaging device with the above structure, the second urging member can easily apply the urging force in the rotation direction.

In the above imaging device, the first urging member (2) may urge the lens barrel relative to the holder rearward in the optical axis direction. The lens barrel may include at least one movement restrictor (31) that restricts movement in the optical axis direction. The at least one movement restrictor may have a rear surface in the optical axis direction in contact with a front surface of the holder in the optical axis direction.

In the imaging device with the above structure, the lens barrel is prevented from moving in the optical axis direction when touched by the user of the imaging device from the front in the optical axis direction. This prevents changes in the distance between the lens and the image sensor, thus reducing defocusing.

In the above imaging device, the at least one movement restrictor may include a plurality of movement restrictors on an outer circumferential surface of the lens barrel. The holder may have an opening receiving the lens barrel, and a plurality of cutouts on an outer edge of the opening at positions corresponding to the plurality of movement restrictors. The cutouts may each have an area greater than a corresponding one of the movement restrictors in a plan view perpendicular to the optical axis. The opening may have, on a plane perpendicular to the optical axis, an outer diameter smaller than a diameter of an outer circumference of the plurality of movement restrictors.

The imaging device with the above structure can be easily assembled by placing the lens barrel into the holder from the rear in the optical axis direction without any additional member. After the assembly, the lens barrel is rotated about the optical axis. The outer edge of the opening in the holder thus prevents the movement restrictors from slipping in the optical axis direction, thus reducing the possibility that the lens barrel slips off the holder.

In the above imaging device, the first urging member may be a compression spring (2) located radially outside the lens barrel.

In the imaging device with the above structure, the relatively simple structure allows the lens barrel to be in position with respect to the holder.

In the above imaging device, the at least one second urging member may include a tension spring (4a to 4d).

In the imaging device with the above structure, the relatively simple structure allows the substrate and the image sensor to be in position with respect to the holder.

In the above imaging device, the at least one positioning member may include three or more positioning members. The at least one second urging member may include two urging members. Connectors on the substrate connected with the second urging members may be located inward from a polygon including the positioning members on a plane perpendicular to the optical axis.

In the imaging device with the above structure, the substrate is not loosened from the holder under the urging force of the second urging member located outward from the polygon including the positioning members. The substrate can thus be retained more stably in position with respect to the holder for easy adjustment of the tilt between the image sensor mounted on the substrate and the lens.

In the above imaging device, the at least one positioning member may include three or more positioning members. The at least one second urging member may include two urging members. A connector on the substrate connected with one of the two second urging members may be located inward from a polygon including the positioning members on a plane perpendicular to the optical axis. One of the two second urging members may apply, in a rotation direction about the optical axis, an urging force to the holder in a direction opposite to a direction in which another of the two second urging members applies an urging force to the holder.

In the imaging device with the above structure, the urging force of the second urging member located outward from the polygon including the positioning members reduces the possibility that the substrate is loosened from the holder. The substrate can thus be retained more stably in position with respect to the holder for easy adjustment of the tilt between the image sensor mounted on the substrate and the lens.

In the imaging device according to the first aspect of the present invention, the at least one second urging member may urge the substrate relative to the holder rearward in the optical axis direction.

The imaging device with the above structure allows relatively easy positioning with respect to the optical axis in any direction. Without using an adhesive, this structure reduces the possibility that the optical axis is misaligned under temperature changes after the device assembly. This increases precision in adjusting the optical axis, and improves reliability.

In the above imaging device, the at least one fastener may include a plurality of fasteners (6a to 6c). The plurality of fasteners may each independently adjust the distance between the holder and the substrate in the optical axis direction.

The imaging device with the above structure allows easy adjustment of the tilt between the image sensor mounted on the substrate and the lens.

In the above imaging device, the at least one fastener may include three fasteners (6a to 6c).

In the imaging device with the above structure, the simple structure allows more stable adjustment of the tilt between the image sensor mounted on the substrate and the lens.

In the above imaging device, the substrate may have a through-hole (52a to 52c) receiving the at least one fastener. The at least one fastener may be placed through the through-hole from rear to front in the optical axis direction.

The imaging device with the above structure allows access to the fastener from the rear in the optical axis direction for adjustment of the distance and the tilt between the image sensor and the lens.

In the above imaging device, the at least one fastener may include a screw. The distance between the holder and the substrate in the optical axis direction may vary in accordance with a length of thread engagement between the screw and the holder.

The imaging device with the above structure allows relatively easy adjustment of the distance and the tilt between the image sensor and the lens using the screw.

In the above imaging device, the first urging member (2) may urge the lens barrel relative to the holder rearward in the optical axis direction. The lens barrel may include at least one movement restrictor (31) that restricts movement in the optical axis direction. The at least one movement restrictor may have a rear surface in the optical axis direction in contact with a front surface of the holder in the optical axis direction.

In the imaging device with the above structure, the lens barrel is prevented from moving in the optical axis direction when touched by the user of the imaging device from the front in the optical axis direction. This prevents changes in the distance between the lens and the image sensor, thus reducing defocusing.

In the above imaging device, the at least one movement restrictor may include a plurality of movement restrictors on an outer circumferential surface of the lens barrel. The holder may have an opening receiving the lens barrel, and a plurality of cutouts on an outer edge of the opening at positions corresponding to the plurality of movement restrictors. The cutouts may each have an area greater than a corresponding one of the movement restrictors in a plan view perpendicular to the optical axis. The opening may have, on a plane perpendicular to the optical axis, an outer diameter smaller than a diameter of an outer circumference of the plurality of movement restrictors.

The imaging device with the above structure can be easily assembled by placing the lens barrel into the holder from the rear in the optical axis direction without any additional member. After the assembly, the lens barrel is rotated about the optical axis. The outer edge of the opening in the holder thus prevents the movement restrictors from slipping in the optical axis direction, thus reducing the possibility that the lens barrel slips off the holder.

In the above imaging device, the first urging member may be a compression spring located radially outside the lens barrel.

In the imaging device with the above structure, the relatively simple structure allows the lens barrel to be in position with respect to the holder.

In the above imaging device, the at least one second urging member may include a compression spring located radially outside the at least one fastener.

In the imaging device with the above structure, the relatively simple structure allows the substrate and the image sensor to be in position with respect to the holder.

In the above imaging device, the at least one second urging member (4d) may include a torsion spring that urges the holder in a rotation direction relative to the substrate.

In the imaging device with the above structure, the holder is urged in the rotation direction relative to the substrate to eliminate rattling. The holder can thus be retained in position in the rotation direction with respect to the substrate.

In the above imaging device, the at least one second urging member may include a first arm (41) in contact with the holder and a second arm (42) in contact with the substrate.

In the imaging device with the above structure, the first arm and the second arm each generate an urging force acting in the rotation direction. The relatively simple structure can thus retain the holder in position in the rotation direction with respect to the substrate.

### BRIEF DESCRIPTION OF DRAWINGS

FIG. 1 is an external perspective view of an imaging device according to a first embodiment as viewed from the front in the optical axis direction.

FIG. 2 is an exploded perspective view of the imaging device according to the first embodiment as viewed from the front in the optical axis direction.

FIG. 3 is an exploded perspective view of the imaging device according to the first embodiment as viewed from the rear in the optical axis direction.

FIG. 4 is a plan view of the imaging device according to the first embodiment as viewed from the front in the optical axis direction.

FIG. 5 is a cross-sectional view of the imaging device according to the first embodiment taken along line A-A in FIG. 4.

FIG. 6 is an external perspective view of an imaging device according to a second embodiment as viewed from the front in the optical axis direction.

FIG. 7 is an exploded perspective view of the imaging device according to the second embodiment as viewed from the front in the optical axis direction.

FIG. 8 is an exploded perspective view of the imaging device according to the second embodiment as viewed from the rear in the optical axis direction.

FIG. 9 is a plan view of the imaging device according to the second embodiment as viewed from the front in the optical axis direction.

FIG. 10 is a cross-sectional view of the imaging device according to the second embodiment taken along line A-A in FIG. 9.

FIG. 11 is an external perspective view of an imaging device according to a third embodiment as viewed from the front in the optical axis direction.

FIG. 12 is an exploded perspective view of the imaging device according to the third embodiment as viewed from the front in the optical axis direction.

FIG. 13 is an exploded perspective view of the imaging device according to the third embodiment as viewed from the rear in the optical axis direction.

FIG. 14 is a plan view of the imaging device according to the third embodiment as viewed from the front in the optical axis direction.

FIG. 15 is a cross-sectional view of the imaging device according to the third embodiment taken along line A-A in FIG. 14.

FIG. 16 is a cross-sectional view of the imaging device according to the third embodiment taken along line B-B in FIG. 15.

FIG. 17 is an external perspective view of an imaging device according to a fourth embodiment as viewed from the front in the optical axis direction.

FIG. 18 is an exploded perspective view of the imaging device according to the fourth embodiment as viewed from the front in the optical axis direction.

FIG. 19 is an exploded perspective view of the imaging device according to the fourth embodiment as viewed from the rear in the optical axis direction.

FIG. 20 is a plan view of the imaging device according to the fourth embodiment as viewed from the front in the optical axis direction.

FIG. 21 is a cross-sectional view of the imaging device according to the fourth embodiment taken along line A-A in FIG. 20.

FIG. 22 is an exploded perspective view of an imaging device according to a fifth embodiment as viewed from the front in the optical axis direction.

FIG. 23 is an exploded perspective view of the imaging device according to the fifth embodiment as viewed from the rear in the optical axis direction.

FIG. 24 is an enlarged view of a torsion spring and its periphery in the imaging device according to the fifth embodiment.

FIG. 25 is an enlarged view of the torsion spring and its periphery in the imaging device according to the fifth embodiment.

FIG. 26 is an enlarged view of the torsion spring and its periphery in the imaging device according to the fifth embodiment.

FIG. 27 is a cross-sectional view of the imaging device according to the fifth embodiment.

### DETAILED DESCRIPTION

An imaging device according to one embodiment of the present invention has a relatively simple structure for easily adjusting the positions of a lens held in a lens barrel and an image sensor mounted on a substrate with respect to a holder. The relatively easy adjustment enables highly precise adjustment of the optical axis. This structure allows all the adjustment operations for the optical axis from the front in the optical axis direction.

An optical axis herein refers to the center of a lens, and also the center of light entering the image sensor. An imaging target located opposite to the image sensor from the lens is referred to as a subject. The front in the optical axis direction or frontward may refer to the direction in which the subject is located as viewed from the lens. The rear in the optical axis direction or rearward may refer to the direction in which the image sensor is located as viewed from the lens. The figures may show X-axis, Y-axis, and Z-axis that are orthogonal to one another. Z-axis is parallel to the optical axis.

The structures according to embodiments of the present invention will now be described. The embodiments described below are mere examples of the present invention, and should not be construed as limiting the technical scope of the invention. In the figures, the same components are given the same reference numerals, and may not be described.

1. First Embodiment

2. Second Embodiment

3. Third Embodiment

4. Fourth Embodiment

5. Fifth Embodiment

6. Supplemental Examples

### 1. First Embodiment

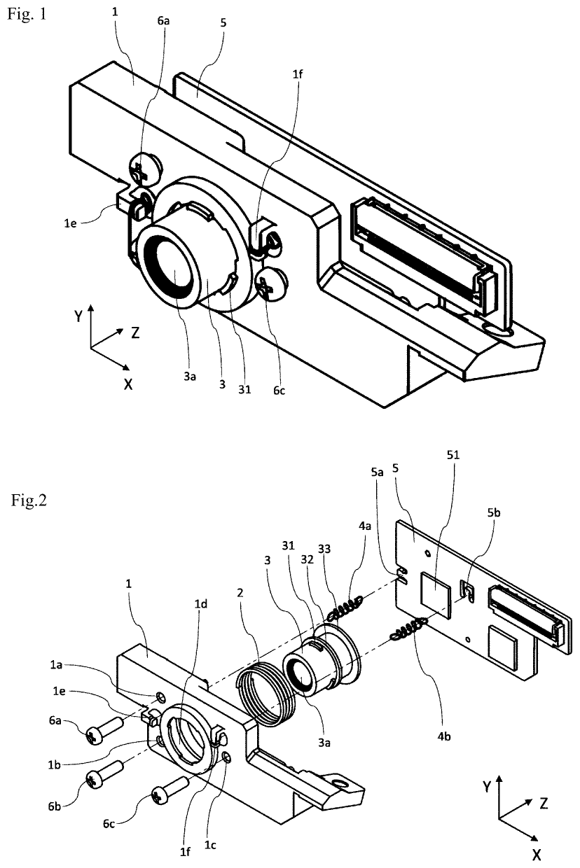

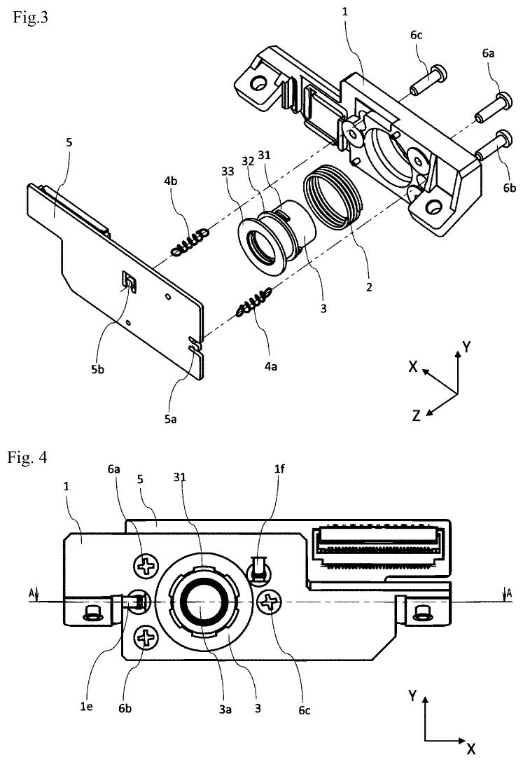

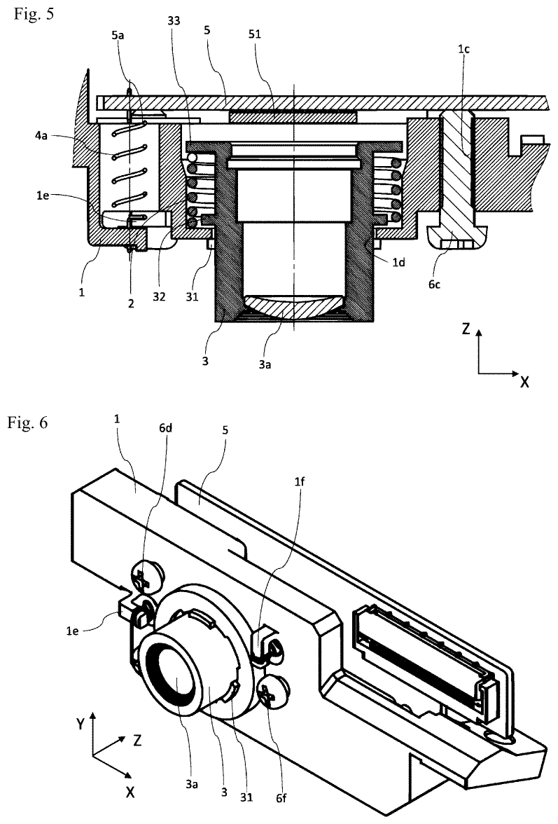

A first embodiment of the present invention will be described first with reference to FIGS. 1 to 5. FIG. 1 is an external perspective view of an imaging device according to the present embodiment as viewed from the front in the optical axis direction. FIGS. 2 and 3 are exploded perspective views of the imaging device according to the present embodiment showing the components. FIG. 2 is a front view in the optical axis direction, and FIG. 3 is a rear view in the optical axis direction. FIG. 4 is a plan view of the imaging device according to the present embodiment as viewed from the front in the optical axis direction. FIG. 5 is a cross-sectional view taken along line A-A in FIG. 4.

As shown mainly in FIGS. 2 and 3, the imaging device according the present embodiment includes a holder 1, a compression spring 2, a lens barrel 3, tension springs 4a and 4b, a substrate 5, and screws 6a to 6c.

### Holder 1

The holder 1 holds the compression spring 2, the lens barrel 3, the tension springs 4a and 4b, and the substrate 5. The holder 1 has a cylindrical opening 1d extending through the holder 1 at the front in the optical axis direction. The compression spring 2 and the lens barrel 3 are held radially inside the opening 1d. The holder 1 has through-holes 1a to 1c for the screws 6a to 6c. The radially inner surfaces of the through-holes 1a to 1c are threaded. The holder 1 includes first spring connectors 1e and 1f connected to the front ends of the tension springs 4a and 4b in the optical axis direction. The first spring connectors 1e and 1f are located on the front surface of the holder 1 in the optical axis direction. The holder 1 has, at the positions of the first spring connectors 1e and 1f, through-holes through which the tension springs 4a and 4b are received. The compression spring 2 and the lens barrel 3 are placed in the opening 1d in the holder 1 from the rear in the optical axis direction.

As shown in FIG. 5, the frontmost portion of the holder 1 in the optical axis direction defining the opening 1d is held between first protrusions 31 and a second protrusion 32 located on the lens barrel 3. The holder 1 has the front surface in the optical axis direction in contact with the rear surfaces of the first protrusions 31 on the lens barrel 3 in the optical axis direction. The holder 1 is urged by the compression spring 2 frontward in the optical axis direction relative to the lens barrel 3. The front surface of the holder 1 in the optical axis direction is thus in contact with the rear surface the first protrusions 31 of the lens barrel 3 in the optical axis direction while being urged frontward in the optical axis direction. The holder 1 and the lens barrel 3 are thus retained stably in position in the optical axis direction. The first protrusions 31 each are an example of a movement restrictor for restricting movement in the optical axis direction.

As shown in FIG. 2, the frontmost portion of the holder 1 in the optical axis direction has three cutouts at the opening 1d. The cutouts extend radially outward from the circumference of the opening 1d. The area of each cutout on a plane perpendicular to the optical axis is smaller than the area of the corresponding first protrusion 31. The diameter of the opening 1d is smaller than the diameter of the outer circumference of the first protrusions 31. The three cutouts receive three first protrusions 31 on the lens barrel 3 placed from the rear to the front in the optical axis direction. With the first protrusions 31 on the lens barrel 3 received in the cutouts, the lens barrel 3 is rotated relative to the holder 1 about the optical axis. The first protrusions 31 are thus moved out of alignment with the cutouts as viewed in the optical axis direction, connecting the lens barrel 3 to the holder 1. In this manner, the outer edge of the opening is located rearward from the first protrusions 31 in the optical axis direction. This structure prevents the lens barrel 3 from slipping off the holder 1 rearward in the optical axis direction.

The holder 1 is located at a distance to the substrate 5 adjusted by the screws 6a to 6c, and is connected to the substrate 5 with the tension springs 4a and 4b. More specifically, the holder 1 and the substrate 5 are retained in position while being urged toward each other by the tension springs 4a and 4b. The distance retained between the holder 1 and the substrate 5 is adjusted by the screws 6a to 6c placed through the holder 1 with the screw ends in contact with the substrate 5. The screws 6a to 6c each are an example of a positioning member in an aspect of the present invention.

### Compression Spring 2

The compression spring 2 is a cylindrical and helical coil spring. The compression spring 2 is located radially outside the lens barrel 3 and between the lens barrel 3 and the holder 1 in the direction perpendicular to the optical axis (in a radial direction). The compression spring 2 has a front end in the optical axis direction in contact with the holder 1 and a rear end in the optical axis direction in contact with a rear flange 33 on the lens barrel 3. The compression spring 2 urges the holder 1 and the lens barrel 3 away from each other. The compression spring 2 may be replaced with another urging member, such as a leaf spring. The compression spring 2 is an example of a first urging member in an aspect of the present invention.

### Lens Barrel 3

The lens barrel 3 is a cylinder elongated along the optical axis. The lens barrel 3 holds one or more optical members including the lens 3a. The lens barrel 3 includes the first protrusions 31 and the second protrusion 32 protruding radially outward from the cylinder. The three first protrusions 31 protruding radially outward from the lens barrel 3 are arranged discontinuously on the circumference. The second protrusion 32 protruding radially outward from the lens barrel 3 extends continuously along the circumference.

The lens barrel 3 has the rear flange 33 extending radially outward on the rear end in the optical axis direction. The front surface of the rear flange 33 on the lens barrel 3 in the optical axis direction is in contact with the rear end of the compression spring 2 in the optical axis direction. The lens barrel 3 is thus urged rearward in the optical axis direction relative to the holder 1.

The optical members held in the lens barrel 3 include, for example, a lens, a spacer, aperture blades, and an optical filter (not shown), in addition to the lens 3a. The lenses including the lens 3a are formed from a transparent material, such as glass or plastic, to transmit light from the front to the rear in the optical axis direction while refracting the light. The spacer is a disk with an appropriate thickness in the optical axis direction. The spacer adjusts the positions of the lenses in the optical axis direction. The spacer has an opening in the middle including the optical axis. The aperture blades determine the outermost position of passing light. The optical filter prevents or blocks passage of light with a predetermined wavelength. The optical filter may include, for example, an infrared cut-off filter that prevents infrared rays from passing. The number of optical members used can be changed as appropriate.

The lens barrel 3 is not fitted in position with any component including the holder 1 and the substrate 5 by, for example, thread engagement, but is movable (displaceable) on an XY plane perpendicular to the optical axis. During assembly, the lens barrel 3 is moved relative to the holder 1 on the XY plane to adjust the optical axis. After the lens barrel 3 is positioned with respect to the holder 1, the lens barrel 3 may be fixed with, for example, an adhesive as appropriate for more firmly fixing to the holder 1.

### Tension Springs 4a and 4b

The tension springs 4a and 4b each include a cylindrical and helical body and hook-shaped front and rear ends in the optical axis direction. The hook-shaped ends protrude from the body. The connecting ends of the tension springs 4a and 4b are hooked on the first spring connectors 1e and 1f on the holder 1. This connects the substrate 5 to the holder 1. The tension springs 4a and 4b urge the holder 1 and the substrate 5 toward each other. In other words, the substrate 5 is urged frontward in the optical axis direction toward the holder 1. The tension springs 4a and 4b may each be replaced with another urging member, such as a leaf spring. The tension springs 4a and 4b each are an example of a second urging member in an aspect of the present invention.

### Substrate 5

The substrate 5 is a rigid substrate on which electronic components including the image sensor 51 are mounted. The image sensor 51 is a photoelectric converter that converts incident light to electrical signals. The image sensor 51 is, for example, a complementary metal-oxide-semiconductor (CMOS) sensor or a charge-coupled device (CCD), but is not limited to such devices. The imaging device may include an imaging unit having the imaging function other than the image sensor 51.

As shown in FIG. 5, the substrate 5 includes second spring connectors 5a and 5b connected to the rear ends of the tension springs 4a and 4b in the optical axis direction. The second spring connectors 5a and 5b are aligned with the first spring connectors 1e and 1f in the optical axis direction. In other words, in a plan view perpendicular to the optical axis, the first spring connectors 1e and 1f overlap the second spring connectors 5a and 5b.

The substrate 5 connected to the holder 1 with the tension springs 4a and 4b is at a distance to the holder 1 adjusted by the three screws 6a to 6c. Adjusting the lengths of the screws 6a to 6c engaged with the through-holes 1a to 1c in the holder 1 can vary the distance between the substrate 5 and the holder 1 at the respective positions of the screws 6a to 6c. Thus, varying the thread engagement lengths of the screws 6a to 6c can vary the distance between the substrate 5 and the holder 1 in the optical axis direction (along Z-axis) and can adjust the tilt of the substrate 5 to the holder 1. The substrate 5 positioned with respect to the holder 1 may be fixed with, for example, an adhesive as appropriate for more firmly fixing to the holder 1.

The substrate 5 may include multiple rigid substrates connected with a flexible substrate, rather than being a single rigid substrate. In this case, the substrate on which an image sensor is mounted corresponds to the substrate 5 according to the present embodiment.

In the imaging device according to the present embodiment, the lens barrel 3 is movable relative to the holder 1 in a direction perpendicular to the optical axis. The distance to the substrate 5 from the holder 1 in the optical axis direction can be adjusted with the screws 6a to 6c. This allows relatively easy positioning with respect to the optical axis in any direction. Without using an adhesive, this structure reduces the possibility that the optical axis is misaligned under temperature changes after the device assembly. This increases precision in adjusting the optical axis, and improves reliability. The heads of the screws 6a to 6c protrude frontward in the optical axis direction. This allows adjustment of the distance and the tilt between the holder 1 and the substrate 5 from the front in the optical axis direction. This also allows all the adjustment operations for the optical axis from the front in the optical axis direction, thus increasing the efficiency of adjusting the optical axis.

The compression spring 2 may urge the lens barrel 3 relative to the holder 1 frontward in the optical axis direction, rather than rearward. In this structure as well, the lens barrel 3 can be retained stably in position in the holder 1.

In the imaging device according to the present embodiment, the three screws 6a to 6c can each independently be used for positioning. This allows easy adjustment of the tilt between the image sensor 51 mounted on the substrate 5 and the lens 3a or another component in the lens barrel 3.

In the imaging device according to the present embodiment, the screws 6a to 6c are used as positioning members for adjusting the distance between the holder 1 and the substrate 5. The distance between the holder 1 and the substrate 5 in the optical axis direction can vary in accordance with the thread engagement lengths between the screws 6a to 6c and the holder 1. The relatively simple structure can thus retain the holder 1 and the substrate 5 stably in position. The screws 6a to 6c may be replaced with other members such as cams.

In the imaging device according to the present embodiment, the lens barrel 3 includes the first protrusions 31. The rear surface of each first protrusion 31 in the optical axis direction is in contact with the front surface of the holder 1 in the optical axis direction. The holder 1 is urged frontward in the optical axis direction by the compression spring 2. This structure prevents the lens barrel 3 from moving in the optical axis direction when touched by the user of the imaging device from the front in the optical axis direction. This prevents changes in the distance between, for example, the lens 3a held in the lens barrel 3 and the image sensor 51 on the substrate 5, thus reducing defocusing.

The compression spring 2 may be replaced with an urging member other than a compression spring. The tension springs 4a and 4b may be replaced with urging members other than tension springs.

In the imaging device according to the present embodiment, the holder 1 has cutouts in the opening 1d, and the lens barrel 3 includes the first protrusions 31. This structure prevents the lens barrel 3 from slipping off the holder 1.

In the imaging device according to the present embodiment, the tension springs 4a and 4b and the connectors 1e, 1f, 5a, and 5b for connecting the tension springs 4a and 4b to the holder 1 and the substrate 5 are located in an area surrounded by the screws 6a to 6c in a plan view perpendicular to the optical axis. This structure retains the substrate 5 more stably in position with respect to the holder 1.

### 2. Second Embodiment

A second embodiment of the present invention will now be described with reference to FIGS. 6 to 10. The present embodiment differs from the first embodiment in including shoulder screws 6d to 6f in place of the screws 6a to 6c. The other components are the same as in the first embodiment. The present embodiment will be described focusing on its differences from the first embodiment, without the same components being described.

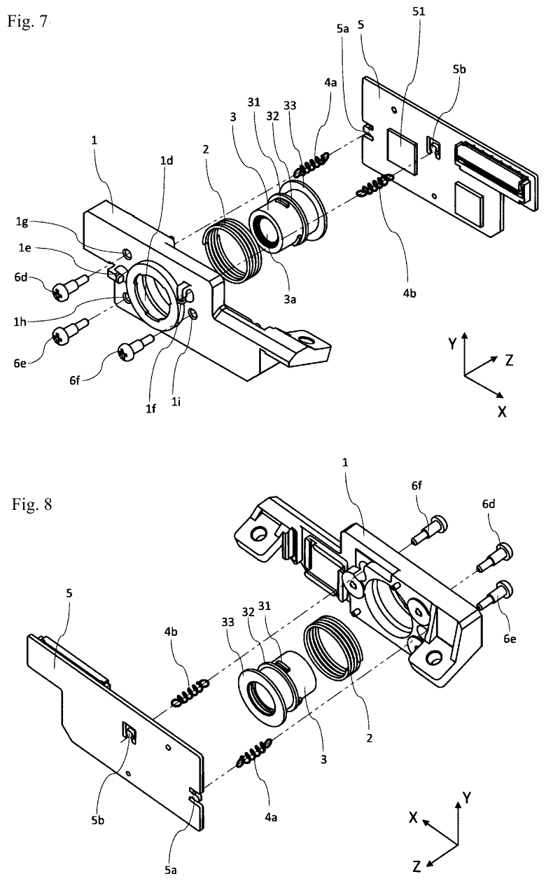

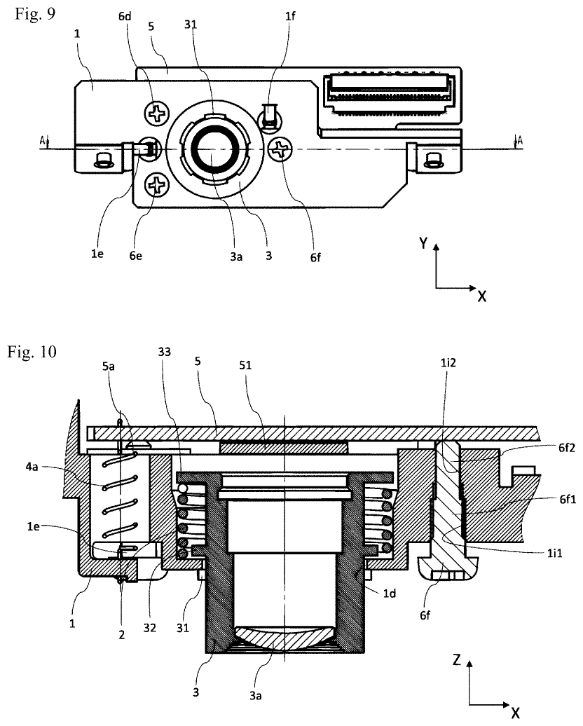

FIG. 6 is an external perspective view of an imaging device according to the present embodiment as viewed from the front in the optical axis direction. FIGS. 7 and 8 are exploded perspective views of the imaging device according to the present embodiment showing the components. FIG. 7 is a front view in the optical axis direction, and FIG. 8 is a rear view in the optical axis direction. FIG. 9 is a plan view of the imaging device according to the present embodiment as viewed from the front in the optical axis direction. FIG. 10 is a cross-sectional view taken along line A-A in FIG. 9.

As illustrated, the imaging device according the present embodiment includes a holder 1, a compression spring 2, a lens barrel 3, tension springs 4a and 4b, a substrate 5, and the shoulder screws 6d to 6f.

### Shoulder Screws 6d to 6f

The shoulder screws 6d to 6f each have a head and a shank in the same manner as typical screws. However, the shank of, for example, the shoulder screw 6f includes a threaded first shank section 6f1 and an unthreaded second shank section 6f2 with a smooth outer peripheral surface (refer particularly to FIG. 10). The shoulder screws 6d to 6f are placed through the through-holes 1g to 1i in the holder 1. The threaded first shank section 6f1 placed through the through-hole 1i (or the through-hole 1g or 1h) in the holder 1 is in thread engagement with a thread 1i1, whereas the second shank section 6f2 is simply received in a far portion 1i2 of the through-hole 1i (or the through-hole 1g or 1h) in the holder 1 without thread engagement.

In the imaging device according to the present embodiment, the shoulder screws 6d to 6f as described above are used to avoid thread engagement with the holder 1 adjacent to the substrate 5. This eliminates wear debris resulting from thread engagement, and can prevent such wear debris from accumulating on the image sensor 51.

### 3. Third Embodiment

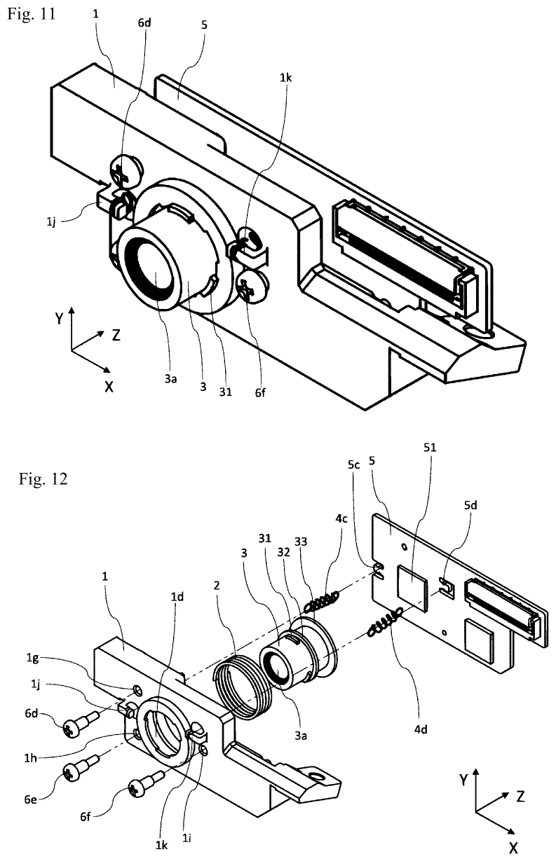

A third embodiment of the present invention will now be described with reference to FIGS. 11 to 16. The present embodiment differs from the second embodiment in including tension springs 4c and 4d in place of the tension springs 4a and 4b. The tension springs 4c and 4d apply different urging forces to the holder 1 and the substrate 5. The other components are the same as in the second embodiment. The present embodiment will be described focusing on its differences from the second embodiment, without the same components being described.

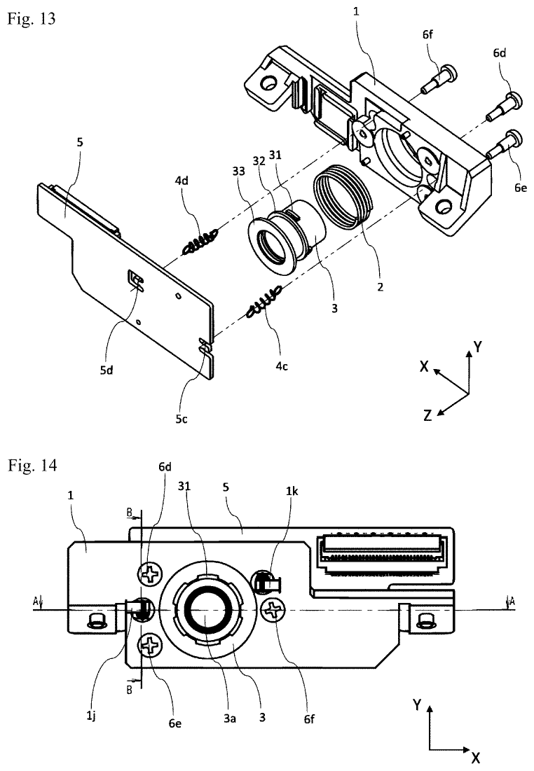

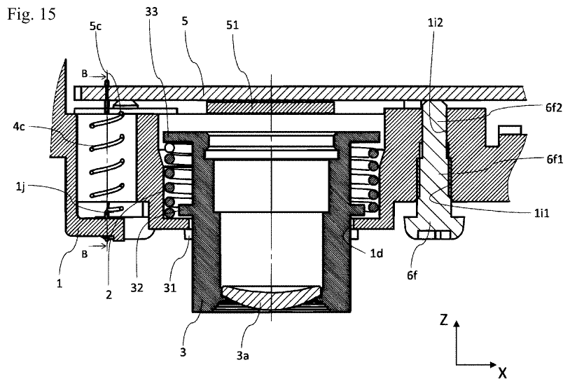

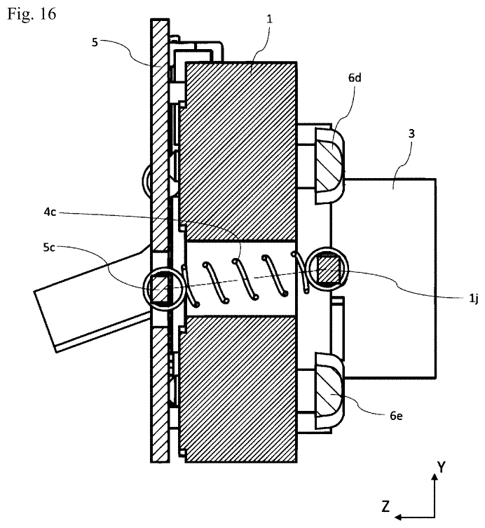

FIG. 11 is an external perspective view of an imaging device according to the present embodiment as viewed from the front in the optical axis direction. FIGS. 12 and 13 are exploded perspective views of the imaging device according to the present embodiment showing the components. FIG. 12 is a front view in the optical axis direction, and FIG. 13 is a rear view in the optical axis direction. FIG. 14 is a plan view of the imaging device according to the present embodiment as viewed from the front in the optical axis direction. FIG. 15 is a cross-sectional view taken along line A-A in FIG. 14. FIG. 16 is a cross-sectional view taken along line B-B in FIG. 15.

As illustrated, the imaging device according the present embodiment includes a holder 1, a compression spring 2, a lens barrel 3, the tension springs 4c and 4d, a substrate 5, and screws 6d to 6f.

### Tension Springs 4c and 4d

Although the tension springs 4c and 4d have the same shape as those in the first embodiment, they are arranged differently to each generate an urging force acting in a different direction. More specifically, first spring connectors 1j and 1k on the holder 1 and second spring connectors 5c and 5d on the substrate 5 are located at different positions in a plan view perpendicular to the optical axis without overlapping with each other. In other words, the tension springs 4c and 4d are not parallel but oblique to the optical axis. The tension springs 4c and 4d thus apply, to the holder 1 and the substrate 5, an urging force acting in a direction perpendicular to the optical axis, that is, the direction of rotation about the optical axis, in addition to an urging force pulling the holder 1 and the substrate 5 toward each other.

When the first spring connectors 1j and 1k are located outside the triangle defined by the screws 6d to 6f on a plane perpendicular to the optical axis, the urging force of the tension springs 4c and 4d and the function of the screws 6d to 6f may cause loosening of the substrate 5 from the holder 1. In this case, the substrate 5 may be unstably retained with respect to the holder 1, possibly causing misalignment with respect to the optical axis.

The first spring connectors 1j and 1k located inward from the triangle defined by the screws 6d to 6f on a plane perpendicular to the optical axis reduce the possibility that the substrate 5 is loosened from the holder 1.

When at least one of the first spring connectors 1j and 1k is located outside the triangle defined by the screws 6d to 6f on a plane perpendicular to the optical axis, an urging force acting in the opposite direction may be applied to the holder 1 from the tension springs 4c and 4d in the rotation direction about the optical axis. This structure reduces the possibility that the substrate 5 is loosened from the holder 1.

In the imaging device according to the present embodiment described above, an urging force acts in the rotation direction of the lens barrel 3. This reduces rattling of the lens barrel 3 on the holder 1 in the rotation direction, thus allowing the lens barrel 3 to rotate in position.

Although the two tension springs 4c and 4d are used in the present embodiment, one or more tension springs may be used as appropriate. The structure including two tension springs may retain the holder 1 and the substrate 5 stably in position appropriately and sufficiently.

### 4. Fourth Embodiment

A fourth embodiment of the present invention will be described with reference to the drawings. The present embodiment will be described in detail focusing on its differences from the first embodiment, without the components common to the first embodiment being described.

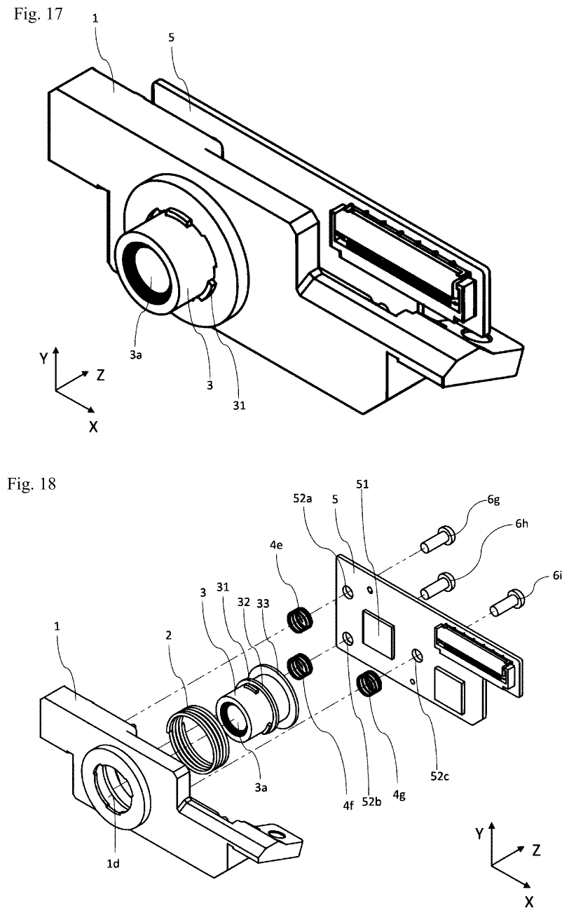

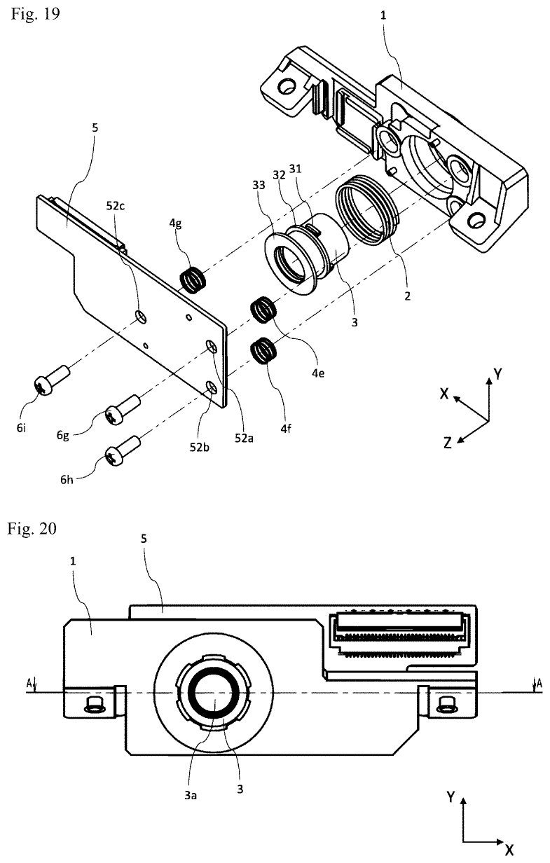

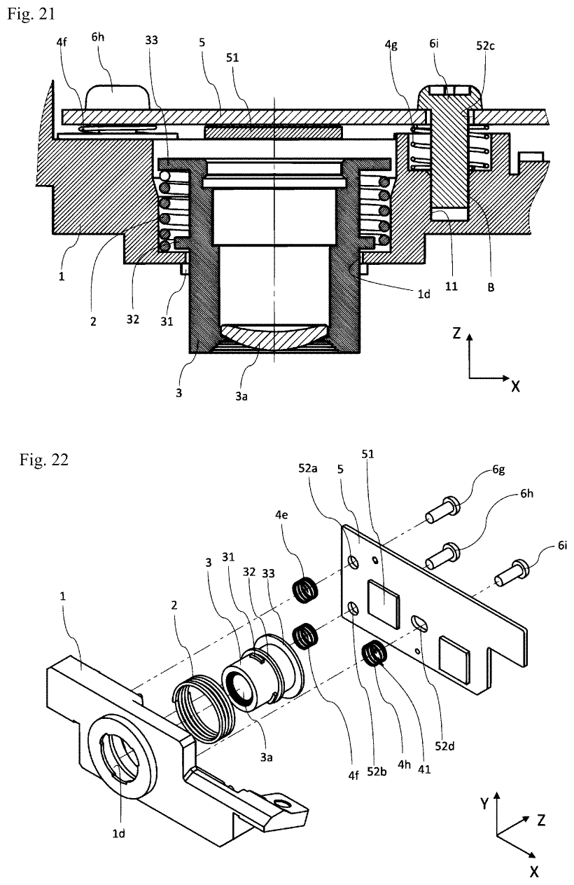

FIG. 17 is an external perspective view of an imaging device according to the present embodiment as viewed from the front in the optical axis direction. FIGS. 18 and 19 are exploded perspective views of the imaging device according to the present embodiment showing the components. FIG. 18 is a front view in the optical axis direction, and FIG. 19 is a rear view in the optical axis direction. FIG. 20 is a plan view of the imaging device according to the present embodiment as viewed from the front in the optical axis direction. FIG. 21 is a cross-sectional view taken along line A-A in FIG. 20.

As shown mainly in FIGS. 18 and 19, the imaging device according the present embodiment includes a holder 1, a compression spring 2, a lens barrel 3, compression springs 4e to 4g, a substrate 5, and connection screws 6g to 6i.

### Holder 1

The holder 1 holds the compression spring 2, the lens barrel 3, the compression springs 4e to 4g, and the substrate 5. The holder 1 has a cylindrical opening 1d extending through the holder 1 at the front in the optical axis direction. The compression spring 2 and the lens barrel 3 are held radially inside the opening 1d. The compression spring 2 and the lens barrel 3 are placed in the opening 1d in the holder 1 from the rear in the optical axis direction.

As shown in FIG. 21, the frontmost portion of the holder 1 in the optical axis direction defining the opening 1d is held between first protrusions 31 and a second protrusion 32 located on the lens barrel 3. The holder 1 has the front surface in the optical axis direction in contact with the rear surfaces of the first protrusions 31 on the lens barrel 3 in the optical axis direction. The holder 1 is urged by the compression spring 2 frontward in the optical axis direction relative to the lens barrel 3. The front surface of the holder 1 in the optical axis direction is thus in contact with the rear surface of the lens barrel 3 in the optical axis direction while being urged frontward in the optical axis direction. The holder 1 and the lens barrel 3 are thus retained stably in position in the optical axis direction. The first protrusions 31 each are an example of a movement restrictor for restricting movement in the optical axis direction.

As shown in FIG. 18, the frontmost portion of the holder 1 in the optical axis direction has three cutouts at the opening 1d. The cutouts extend radially outward from the circumference of the opening 1d. The area of each cutout on a plane perpendicular to the optical axis is smaller than the area of the corresponding first protrusion 31. The diameter of the opening 1d is smaller than the diameter of the outer circumference of the first protrusions 31. The three cutouts receive three first protrusions 31 on the lens barrel 3 placed from the rear to the front in the optical axis direction. With the first protrusions 31 on the lens barrel 3 received in the cutouts, the lens barrel 3 is rotated relative to the holder 1 about the optical axis. The first protrusions 31 are thus moved out of alignment with the cutouts as viewed in the optical axis direction, connecting the lens barrel 3 to the holder 1. In this manner, the outer edge of the opening is located rearward from the first protrusions 31 in the optical axis direction. This structure prevents the lens barrel 3 from slipping off the holder 1 rearward in the optical axis direction.

The holder 1 is connected to the substrate 5 with the connection screws 6g to 6i. More specifically, the holder 1 has, at the rear in the optical axis direction, groove-like screw holes 11 (refer to FIG. 21) into which the connection screws 6g to 6i placed through through-holes 52a to 52c in the substrate 5 are placed from the rear in the optical axis direction. The connection screws 6g to 6i and the screw holes 11 are in thread engagement. The connection screws 6g to 6i receive the compression springs 4e to 4g on their shanks. The compression springs 4e to 4g are in contact with the front of the substrate 5 and the rear of the holder 1 in the optical axis direction. The compression springs 4e to 4g urge the holder 1 frontward relative to the substrate 5. In other words, the holder 1 is urged frontward in the optical axis direction by the compression springs 4e to 4g.

The compression spring 2 and the lens barrel 3 in the present embodiment are the same as those in the first embodiment.

### Compression Springs 4e to 4g

The compression springs 4e to 4g are cylindrical and helical coil springs. The compression springs 4e to 4g are located radially outside the corresponding connection screws 6g to 6i. The compression springs 4e to 4g each have the front end in the optical axis direction in contact with the rear surface of the holder 1 in the optical axis direction and the rear end in the optical axis direction in contact with the front surface of the substrate 5 in the optical axis direction. The compression springs 4e to 4g urge the holder 1 and the substrate 5 away from each other. The compression springs 4e to 4g may be replaced with other urging members, such as leaf springs. The compression springs 4e to 4g each are an example of a second urging member in an aspect of the present invention.

### Substrate 5

The substrate 5 is a rigid substrate on which electronic components including the image sensor 51 are mounted. The image sensor 51 is a photoelectric converter that converts incident light to electrical signals. The image sensor 51 is, for example, a CMOS sensor or a CCD, but is not limited to such devices. The imaging device may include an imaging unit having the imaging function other than the image sensor 51.

As shown in FIG. 21, the substrate 5 having the front surface in the optical axis direction in contact with the rear ends of the compression springs 4e to 4g is urged rearward relative to the holder 1. The substrate 5 has the through-holes 52a to 52c (refer to FIG. 19) at the positions facing the three screw holes 11 in the holder 1. The through-holes 52a to 52c receive connection screws 6g to 6i. The heads of the connection screws 6g to 6i are in contact with the rear surface of the substrate 5 in the optical axis direction. In other words, the substrate 5 is urged rearward in the optical axis direction by the compression springs 4e to 4g and pressed by the connection screws 6g to 6i and is thus retained stably in position.

The substrate 5 is connected to the holder 1 with the three connection screws 6g to 6i and with the compression springs 4e to 4g in between. Adjusting the lengths of the connection screws 6g to 6i engaged with the screw holes 11 in the holder 1 can vary the distance between the substrate 5 and the holder 1 at the respective positions of the connection screws 6g to 6i. Thus, varying the thread engagement lengths of the connection screws 6g to 6i can vary the distance between the substrate 5 and the holder 1 in the optical axis direction (along Z-axis) and can adjust the tilt of the substrate 5 to the holder 1. The substrate 5 positioned with respect to the holder 1 may be fixed with, for example, an adhesive as appropriate for more firmly fixing to the holder 1.

The substrate 5 may include multiple rigid substrates connected with a flexible substrate, rather than being a single rigid substrate. In this case, the substrate on which an image sensor is mounted corresponds to the substrate 5 according to the present embodiment.

In the imaging device according to the present embodiment, the lens barrel 3 is movable relative to the holder 1 in a direction perpendicular to the optical axis. The distance to the substrate 5 from the holder 1 in the optical axis direction can be adjusted with the connection screws 6g to 6i. This allows relatively easy positioning with respect to the optical axis in any direction. Without using an adhesive, this structure reduces the possibility that the optical axis is misaligned under temperature changes after the device assembly. This increases precision in adjusting the optical axis, and improves reliability.

The compression spring 2 may urge the lens barrel 3 relative to the holder 1 frontward in the optical axis direction, rather than rearward. In this structure as well, the lens barrel 3 can be retained stably in position in the holder 1.

In the imaging device according to the present embodiment, the three connection screws 6g to 6i can be each independently used for positioning. This allows easy adjustment of the tilt between the image sensor 51 mounted on the substrate 5 and the lens 3a or another component in the lens barrel 3.

Although the number of connection screws connecting the substrate 5 to holder 1 may be other than three, the use of three connection screws allow the relatively simple structure to retain the holder 1 and the substrate 5 stably in position.

In the imaging device according to the present embodiment, the substrate 5 has the through-holes 52a to 52c, through which the connection screws 6g to 6i are placed into the screw holes 11 in the holder 1 from the rear to the front in the optical axis direction. This structure allows access to the connection screws 6g to 6i from the rear in the optical axis direction for adjustment of the distance and the tilt between the image sensor 51 on the substrate 5 and the lens 3a or another optical component in the lens barrel 3.

Although the connection screws 6g to 6i are used to connect the substrate 5 to the holder 1 in the imaging device according to the present embodiment, any fasteners other than screws may be used. However, the use of connection screws can vary the distance between the holder 1 and the substrate 5 in the optical axis direction in accordance with the thread engagement lengths between the connection screws 6g to 6i and the holder 1. This structure allows relatively easy adjustment of the distance and the tilt between the image sensor 51 on the substrate 5 and the lens 3a or another optical component in the lens barrel 3.

In the imaging device according to the present embodiment, the lens barrel 3 includes the first protrusions 31. The rear surface of each first protrusion 31 in the optical axis direction is in contact with the front surface of the holder 1 in the optical axis direction. The holder 1 is urged frontward in the optical axis direction by the compression spring 2. This structure prevents the lens barrel 3 from moving in the optical axis direction when touched by the user of the imaging device from the front in the optical axis direction. This prevents changes in the distance between, for example, the lens 3a held in the lens barrel 3 and the image sensor 51 on the substrate 5, thus reducing defocusing.

Although the compression spring 2 and the compression springs 4e to 4g may be replaced with urging members other than compression springs to provide an intended effect, compression springs allow the relatively simple structure to adjust the optical axis.

### 5. Fifth Embodiment

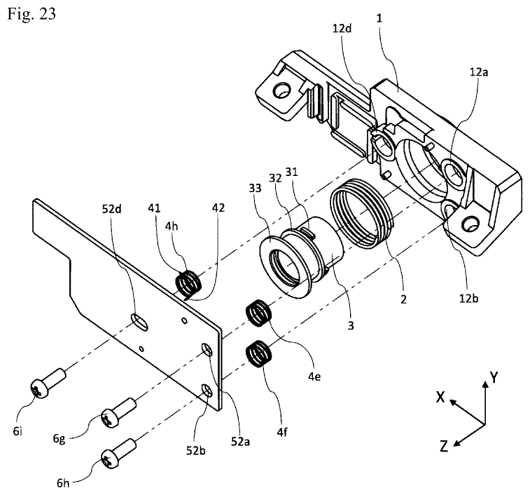

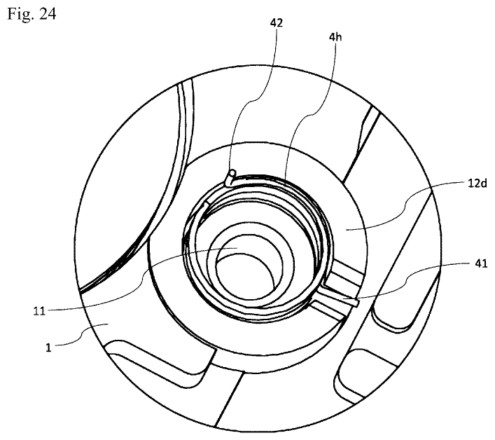

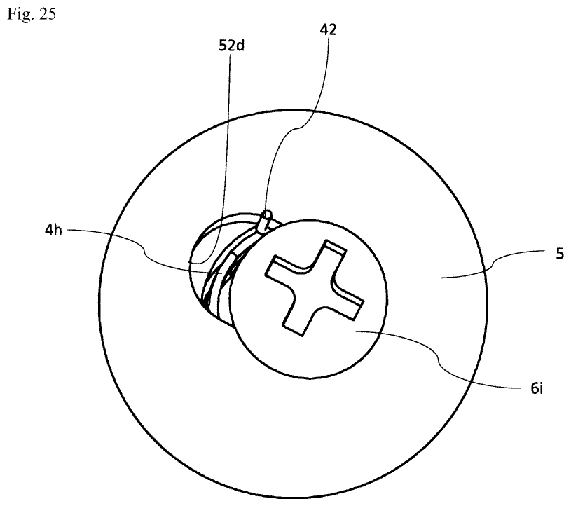

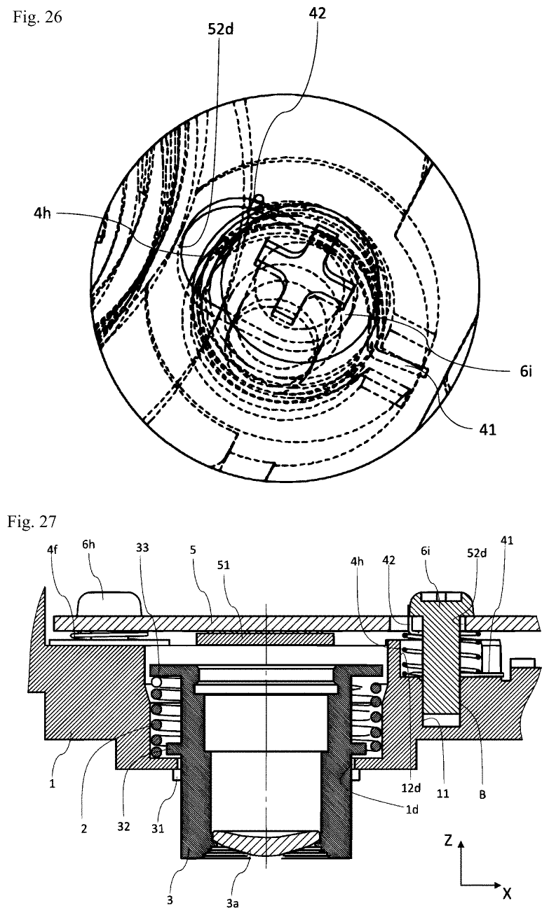

A fifth embodiment of the present invention will now be described with reference to the drawings. FIGS. 22 and 23 are exploded perspective views of an imaging device according to the present embodiment showing the components. FIG. 22 is a front view in the optical axis direction, and FIG. 23 is a rear view in the optical axis direction. FIGS. 22 and 23 correspond to FIGS. 18 and 19 referred to in the fourth embodiment. FIGS. 24 to 26 are enlarged views of a torsion spring 4h and its periphery according to the present embodiment. FIG. 24 is a view of a recess 12d on the holder 1 accommodating the torsion spring 4h before the connection screw 6i is placed. FIGS. 25 and 26 are views of the accommodated torsion spring 4h and its periphery after the connection screw 6i is placed. FIG. 26 is a transparent view of FIG. 25. FIG. 27 is a cross-sectional view of the imaging device according to the present embodiment. FIG. 27 corresponds to FIG. 21 referred to in the fourth embodiment.

As shown in FIGS. 22 and 23, the imaging device according to the present embodiment includes the torsion spring 4h in place of the compression spring 4g in the fourth embodiment.

The holder 1 accommodates the compression springs 4e and 4f and the torsion spring 4h. The holder 1 also has recesses 12a, 12b, and 12d receiving the connection screws 6g to 6i. Whereas the recesses 12a and 12b have simple cylindrical shapes, the recess 12d has a cutout receiving a first arm 41 of the torsion spring 4h (refer particularly to FIG. 24). In other words, the recess 12d accommodates the torsion spring 4h with the first arm 41 received in the cutout. The recess 12d has a screw hole 11 in the bottom at the front in the optical axis direction. The screw hole 11 is threaded for engagement with the connection screw 6i.

As shown in FIGS. 22 and 23, the substrate 5 has a long through-hole 52d in place of the through-hole 52c in the fourth embodiment. The long hole 52d receives the connection screw 6i placed from the rear in the optical axis direction. The connection screw 6i is placed in the recess 12d and into the screw hole 11. The long hole 52d in the substrate 5 receives a second arm 42 of the torsion spring 4h (refer to FIGS. 25 and 26).

The torsion spring 4h includes the first arm 41 and the second arm 42 as described above. The first arm 41 is located on the cutout in the recess 12d on the holder 1. The second arm 42 is in contact with the inner edge of the long hole 52d in the substrate 5. The first arm 41 and the second arm 42 of the torsion spring 4h can each apply an urging force in the rotation direction. The torsion spring 4h thus urges each of the holder 1 and the substrate 5 in the rotation direction. In other words, the substrate 5 is urged relative to the holder 1 in the rotation direction, whereas the holder 1 is urged relative to the substrate 5 in the rotation direction.

As shown in FIG. 25, the second arm 42 of the torsion spring 4h may be in contact with the head of the connection screw 6i, in addition to the inner edge of the long hole 52d.

In the imaging device according to the present embodiment, the torsion spring 4h urges the holder 1 in the rotation direction relative to the substrate 5. The holder 1 is thus retained in position in the rotation direction with respect to the substrate 5 without rattling. The holder 1 and the substrate 5 may thus be retained more precisely and stably in position than in the fourth embodiment.

The torsion spring 4h included in the imaging device according to the present embodiment generates the urging force in the rotation direction with the first arm 41 and the second arm 42. The relatively simple structure can thus retain the holder 1 in position in the rotation direction with respect to the substrate 5.

Although the first arm 41 of the torsion spring 4h is located in the cutout in the recess 12d in the present embodiment, the first arm 41 may be located in any manner to be in contact with the holder 1 and apply the urging force to the holder 1. Although the second arm 42 of the torsion spring 4h is located in the long hole 52d in the present embodiment, the second arm 42 may be located in any manner to be in contact with the substrate 5 and apply the urging force to the substrate 5. More specifically, the holder 1 and the substrate 5 may each have a slot for receiving the first arm 41 or the second arm 42.

Although one of the compression springs 4e to 4g in the fourth embodiment is replaced with the torsion spring 4h in the present embodiment, multiple torsion springs may be used. In this case, the urging force applied to each of the holder 1 and the substrate 5 from the multiple torsion springs may act in the same rotation direction.

### 6. Supplemental Examples

Embodiments of the present invention have been described specifically. The embodiments described above are mere examples. The scope of the present invention is not limited to the embodiments, but is construed broadly within the scope understandable by those skilled in the art.

For example, the first embodiment and the third embodiment may be combined. The shoulder screws 6d to 6f in the third embodiment may be replaced with the screws 6a to 6c. The tension springs may include both the tension spring 4a extending in the optical axis direction as in the first embodiment and the tension spring 4d angled with respect to the optical axis.

The imaging device according to each embodiment of the present invention is particularly useful as an in-vehicle imaging device for automobiles, which involves particularly highly precise adjustment of the optical axis.

### INDUSTRIAL APPLICABILITY

The imaging device according to at least one embodiment of the present invention may be suitably used for an in-vehicle imaging device.

1. An imaging device, comprising:
a substrate on which an image sensor is mounted;
a lens barrel holding a lens;
a holder holding the lens barrel and connected to the substrate;
a first urging member located between the holder and the lens barrel to urge the lens barrel relative to the holder in a direction of an optical axis;
at least one second urging member located between the holder and the substrate to urge the substrate relative to the holder in the optical axis direction; and
at least one fastener connecting the holder and the substrate together to adjust a distance between the holder and the substrate in the optical axis direction,
wherein the lens barrel is movable relative to the holder in a direction perpendicular to the optical axis.

2. The imaging device according to claim 1, wherein
the at least one fastener is at least one positioning member placed through the holder from front to rear in the optical axis direction, and
the at least one second urging member urges the substrate relative to the holder frontward in the optical axis direction.

3. The imaging device according to claim 2, wherein
the at least one positioning member comprises a plurality of positioning members, and
the plurality of positioning members each independently adjust the distance between the holder and the substrate in the optical axis direction.

4. The imaging device according to claim 2, wherein
the at least one positioning member includes a screw, and
the distance between the holder and the substrate in the optical axis direction varies in accordance with a length of thread engagement between the screw and the holder.

5. The imaging device according to claim 2, wherein
the at least one positioning member includes a head and a shank, and
the shank includes a first shank section with a threaded outer peripheral surface, and a second shank section with a smooth outer peripheral surface and in contact with the substrate.

6. The imaging device according to claim 2, wherein
the at least one second urging member urges the substrate relative to the holder frontward in the optical axis direction and in a direction perpendicular to the optical axis.

7. The imaging device according to claim 6, wherein
the at least one second urging member includes at least one spring,
the holder includes a first spring connector connected to one end of the spring,
the substrate includes a second spring connector connected to another end of the spring, and
the first spring connector and the second spring connector are at different positions in a plan view perpendicular to the optical axis.

8. The imaging device according to claim 2, wherein
the first urging member urges the lens barrel relative to the holder rearward in the optical axis direction,
the lens barrel includes at least one movement restrictor configured to restrict movement in the optical axis direction, and
the at least one movement restrictor has a rear surface in the optical axis direction in contact with a front surface of the holder in the optical axis direction.

9. The imaging device according to claim 8, wherein
the at least one movement restrictor comprises a plurality of movement restrictors on an outer circumferential surface of the lens barrel,
the holder has
an opening receiving the lens barrel, and
a plurality of cutouts on an outer edge of the opening at positions corresponding to the plurality of movement restrictors, the cutouts each have an area greater than a corresponding one of the movement restrictors in a plan view perpendicular to the optical axis, and
the opening has, on a plane perpendicular to the optical axis, an outer diameter smaller than a diameter of an outer circumference of the plurality of movement restrictors.

10. (canceled)

11. (canceled)

12. The imaging device according to claim 2, wherein
the at least one positioning member comprises three or more positioning members,
the at least one second urging member comprises two urging members, and
connectors on the substrate connected with the second urging members are located inward from a polygon including the positioning members on a plane perpendicular to the optical axis.

13. The imaging device according to claim 2, wherein
the at least one positioning member comprises three or more positioning members,
the at least one second urging member comprises two urging members,
a connector on the substrate connected with one of the two second urging members is located inward from a polygon including the positioning members on a plane perpendicular to the optical axis, and
one of the two second urging members applies, in a rotation direction about the optical axis, an urging force to the holder in a direction opposite to a direction in which another of the two second urging members applies an urging force to the holder.

14. The imaging device according to claim 1, wherein
the at least one second urging member urges the substrate relative to the holder rearward in the optical axis direction.

15. The imaging device according to claim 14, wherein
the at least one fastener comprises a plurality of fasteners, and
the plurality of fasteners each independently adjust the distance between the holder and the substrate in the optical axis direction.

16. (canceled)

17. The imaging device according to claim 14, wherein
the substrate has a through-hole receiving the at least one fastener, and
the at least one fastener is placed through the through-hole from rear to front in the optical axis direction.

18. The imaging device according to claim 17, wherein
the at least one fastener includes a screw, and
the distance between the holder and the substrate in the optical axis direction varies in accordance with a length of thread engagement between the screw and the holder.

19. The imaging device according to claim 14, wherein
the first urging member urges the lens barrel relative to the holder rearward in the optical axis direction,
the lens barrel includes at least one movement restrictor configured to restrict movement in the optical axis direction, and
the at least one movement restrictor has a rear surface in the optical axis direction in contact with a front surface of the holder in the optical axis direction.

20. The imaging device according to claim 19, wherein
the at least one movement restrictor comprises a plurality of movement restrictors on an outer circumferential surface of the lens barrel,
the holder has
an opening receiving the lens barrel, and
a plurality of cutouts on an outer edge of the opening at positions corresponding to the plurality of movement restrictors, the cutouts each have an area greater than a corresponding one of the movement restrictors in a plan view perpendicular to the optical axis, and
the opening has, on a plane perpendicular to the optical axis, an outer diameter smaller than a diameter of an outer circumference of the plurality of movement restrictors.

21. (canceled)

22. The imaging device according to claim 14, wherein
the at least one second urging member includes a compression spring located radially outside the at least one fastener.

23. The imaging device according to claim 22, wherein
the at least one second urging member includes a torsion spring configured to urge the holder in a rotation direction relative to the substrate.

24. The imaging device according to claim 23, wherein
the at least one second urging member includes a first arm in contact with the holder and a second arm in contact with the substrate.
